(19) United States
(12) Patent Application Publication
(10) Pub. No.: US 2017/0136448 A1
(43) Pub. Date: May 18, 2017

(54) HYDROCRACKING CATALYST AND PROCESS FOR PRODUCING LUBE BASE STOCKS

(71) Applicant: Bi-Zeng ZHAN, Albany, CA (US)

(72) Inventor: Bi-Zeng ZHAN, Albany, CA (US)

(21) Appl. No.: 15/417,146

(22) Filed: Jan. 26, 2017

Related U.S. Application Data
(62) Division of application No. 14/100,239, filed on Dec. 9, 2013, now abandoned.

(51) Int. Cl. B01J 29/16; C10G 67/04; B01J 35/10; C10G 65/12; B01J 23/888; B01J 35/00

(52) U.S. Cl. CPC B01J 29/166; B01J 23/888; B01J 35/0006; B01J 35/1061; B01J 35/1019; B01J 35/1023; B01J 35/1042; B01J 35/1047; C10G 65/12; C10G 67/04; C10G 2400/10

(57) ABSTRACT

Hydrocracking catalysts and hydrocracking processes for the selective production of lube base stocks are disclosed. The hydrocracking catalyst contains a low acidity, highly dealuminated USY zeolite having a zeolite acid site density of from 1 to 100 micromole/g, a catalyst support, and one or more metals. The hydrocracking catalysts can maximize lube base stock yield while providing for effective impurity removal and VI enhancement at lower hydrocracking conversions.

### CROSS-REFERENCE TO RELATED APPLICATIONS

This application is a divisional application of pending U.S. patent application Ser. No. 14/100,239, filed Sep. 13, 2013.

### TECHNICAL FIELD

This disclosure is directed to a catalyst for hydroprocessing a hydrocarbon feedstock under hydroprocessing conditions, methods for making the catalyst, and hydroprocessing processes using the catalyst.

### BACKGROUND

Hydrocracking of hydrocarbon feedstocks is often used to convert lower value hydrocarbon fractions into higher value products, such as conversion of vacuum gas oil (VGO) feedstocks to various fuels and lubricants. Typical hydrocracking reaction schemes can include an initial hydrotreatment step, a hydrocracking step, and a post-hydrotreatment step, such as dewaxing or hydrofinishing. After these steps, the effluent can be fractionated to separate out a desired diesel fuel and/or lube base oil.

Hydrocracking has been combined with hydrotreating as a preliminary step. However, this combination also results in decreased yields of lubricating oils due to the conversion to distillates that typically accompany the hydrocracking process.

Good hydrodenitrogenation (HDN) activity is the main function of hydrocracker (HCR) pretreat catalyst because organic nitrogen-containing compounds are detrimental to the performance of the downstream HCR catalyst. The rate limiting step in the HDN reaction pathway is aromatic ring saturation because the most refractory nitrogen-containing compounds (e.g., substituted carbazoles) are compounds in which the nitrogen atom is incorporated into the aromatic ring at a relatively inaccessible position. Saturation of aromatics also provides for viscosity index (VI) improvement.

There exists a need for hydrocracking catalysts and processes that maximize lube base stock yield while providing for effective impurity removal and VI enhancement at lower hydrocracking conversions.

### SUMMARY

In one aspect, there is provided a hydrocracking catalyst, comprising: (a) a USY zeolite component having a SiO₂/Al₂O₃ mole ratio of at least 50, an alpha value of not more than 5, and a zeolite acid site density of from 1 to 100 micromole/g; (b) an amorphous cracking component; and (c) at least one hydrogenation metal component selected from the group consisting of a Group VIB metal, a Group VIII metal, and mixtures thereof.

In another aspect, there is provided a method for preparing a lube base stock having a viscosity index of from 80 to 140, comprising (a) contacting a hydrocarbon feedstock with a hydrocracking catalyst under hydrocracking conditions sufficient to attain a conversion level of not more than 30% below 700° F. (371° C.), so as to form a hydrocracked product, wherein the hydrocracking catalyst comprises (1) a USY zeolite component having a SiO₂/Al₂O₃ mole ratio of at least 50, an alpha value of not more than 5, and a zeolite acid site density of from 1 to 100 micromole/g; (2) an amorphous cracking component; and (3) at least one hydrogenation metal component selected from the group consisting of a Group VIB metal, a Group VIII metal, and mixtures thereof; (b) separating the hydrocracked product into a converted product having a boiling range maximum of 700° F. (371° C.) and an unconverted product having a boiling range minimum of 700° F. (371° C.); and (c) dewaxing at least a portion of the unconverted product to obtain a lube base stock.

### BRIEF DESCRIPTION OF THE DRAWINGS

FIG. 1 shows a graph of the waxy and dewax viscosity index (VI) of stripper bottom (STB, 670° F.+) as a function of conversion in two different catalyst systems.

FIG. 2 shows a graph of the waxy VI and the hydrocarbon composition of STB (670° F.+) as a function of conversion.

### DETAILED DESCRIPTION

The following terms will be used throughout the specification and will have the following meanings unless otherwise indicated.

The term “hydrocarbon” refers to any compound which comprises hydrogen and carbon and “hydrocarbon feedstock” refers to any charge stock which contains greater than about 90 wt. % carbon and hydrogen.

The term “organic oxygen-containing ligand” refers to any compound comprising at least one carbon atom, at least one oxygen atom, and at least one hydrogen atom wherein the at least one oxygen atom has one or more electron pairs available for coordination to a metal ion. In one embodiment, the oxygen atom is negatively charged at the pH of the reaction.

The term “Group II base oil” refers to a base oil which contains greater than or equal to 90% saturates and less than or equal to 0.03% sulfur and has a viscosity index greater than or equal to 80 and less than 120 using the ASTM methods specified in Table E-1 of American Petroleum Institute Publication 1509.

The term “Group III base oil” refers to a base oil which contains greater than or equal to 90% saturates and less than or equal to 0.03% sulfur and has a viscosity index greater than or equal to 120 using the ASTM methods specified in Table E-1 of American Petroleum Institute Publication 1509.

The term “bulk dry weight” to the weight of a material after calcination at elevated temperature of over 1000° C. for 30 minutes.

When used herein, the Periodic Table of the Elements refers to the version published by CRC Press in the “CRC Handbook of Chemistry and Physics,” 88th Edition (2007-2008). The names for families of the elements in the Periodic Table are given here in the Chemical Abstracts Service (CAS) notation.

Properties of the materials described herein are determined as follows:

(a) “Zeolite acid site density” is a measure of the concentration of Brønsted acid sites in the zeolite and is determined by in situ infrared spectroscopy measurement of the H/D exchange of hydroxyl groups in the zeolite with perdeuterated benzene using the method described by S. M. T. Almutairi et al., Chem. Cat. Chem. 2013, 5, 452-466.

(b) “Alpha value” is determined by an Alpha test adapted from the published descriptions of the Mobil Alpha test (P. B. Weisz et al., J. Catal. 1965 4, 527-529; and J. N. Miale et al., J. Catal. 1966, 6, 278-287). The Alpha value is calculated as the cracking rate of the sample in question divided by the cracking rate of a standard silica alumina sample. The resulting Alpha value is a measure of acid cracking activity which generally correlates with number of acid sites.

(c) “Surface area” is determined by N₂ adsorption at its boiling temperature. BET surface area is calculated by the 5-point method at P/P₀=0.050, 0.088, 0.125, 0.163, and 0.200. Samples are first pre-treated at 400° C. for 6 hours in the presence of flowing, dry N₂ so as to eliminate any adsorbed volatiles like water or organics.

(d) “Micropore volume” is determined by N₂ adsorption at its boiling temperature. Micropore volume is calculated by the t-plot method at P/P₀=0.050, 0.088, 0.125, 0.163, and 0.200. Samples are first pre-treated at 400° C. for 6 hours in the presence of flowing, dry N₂ so as to eliminate any adsorbed volatiles like water or organics.

(e) “Mesopore pore diameter” is determined by N₂ adsorption at its boiling temperature. Mesopore pore diameter is calculated from N₂ isotherms by the BJH method (E. P. Barrett et al., J. Am. Chem. Soc. 1951, 73, 373-380). Samples are first pre-treated at 400° C. for 6 hours in the presence of flowing, dry N₂ so as to eliminate any adsorbed volatiles like water or organics.

(f) “Total pore volume” is determined by N₂ adsorption at its boiling temperature at P/P₀=0.990. Samples are first pre-treated at 400° C. for 6 hours in the presence of flowing, dry N₂ so as to eliminate any adsorbed volatiles like water or organics.

(g) “Unit cell size” is determined by X-ray powder diffraction.

(h) “SiO₂/Al₂O₃ mole ratio” is determined by ICP elemental analysis.

(i) “Pour point” is the temperature at which an oil will begin to flow under controlled conditions, as determined according to ASTM D5950.

(j) “API gravity” is a measure of the gravity or density of a petroleum feedstock/product relative to water, as determined according to ASTM D4052.

(k) “Polycyclic aromatics index” (PCI) is determined according to ASTM D6591.

(l) “Viscosity index” (VI) is an empirical, unit-less number indicated the effect of temperature change on the kinematic viscosity of the oil. The higher the VI of a base oil, the lower its tendency to change viscosity with temperature. VI is determined according to ASTM D2270.

(m) “Kinematic viscosity” is determined according to ASTM D445.

Hydrocracking Catalyst Composition

Catalysts used in carrying out the hydrocracking process includes a USY zeolite component, an amorphous cracking component, one or more metals, optionally one or more binders, and optionally one or more promoters.

(A) Zeolite Component

The catalyst disclosed herein comprises a large pore aluminosilicate zeolite. Large pore zeolites can often have average pore diameters in a range of from 7 Å to 12 Å. Examples of large pore zeolites include *BEA, FAU, LTL, MAZ, MOR, OFF, and VFI framework type zeolites (Ch. Baerlocher et al. “Atlas of Zeolitic Framework Types,” Sixth Revised Edition, Elsevier, 2007).

A particularly suitable large pore zeolite is zeolite Y. Type “Y” zeolites are of the faujasite (“FAU”) framework type. The crystalline zeolite Y is described in U.S. Pat. No. 3,130,007. Zeolite Y and improved Y-type zeolites, such as ultrastable Y (“USY”) zeolite (U.S. Pat. No. 3,375,065) not only provide a desired framework for shape-selective reactions but also exhibit exceptional stability in the presence of steam at elevated temperatures which has resulted in this zeolite structure being utilized in many catalytic petroleum refining and petrochemical processes. A dealuminated Y zeolite for lube hydrocracking is disclosed in U.S. Pat. No. 5,171,422.

Highly dealuminated USY zeolites having a SiO₂/Al₂O₃ mole ratio of at least 50 (e.g., from 50 to 150) are particularly useful as the zeolite component of the catalyst compositions disclosed herein. Preference is given to highly dealuminated USY zeolites having a SiO₂/Al₂O₃ mole ratio of from 80 to 150.

Low acidity, highly dealuminated USY zeolites are particularly advantageous. Low acidity USY zeolites and catalyst compositions therefrom are disclosed in U.S. Pat. Nos. 6,860,986 and 6,902,664. In embodiments, the USY zeolite has an Alpha value of not more than 5 (e.g., from 0.01 to 5, or from 0.01 to 3). In embodiments, the USY zeolite has a zeolite acid site density of from 1 to 100 micromole/g, e.g., from 1 to 90 micromole/g, from 1 to 80 micromole/g, from 1 to 70 micromole/g, from 1 to 60 micromole/g, from 1 to 50 micromole/g, or from 1 to 25 micromole/g.

The use of a catalyst composition comprising a low acidity, highly delauminated USY zeolite was found to produce an unexpectedly high VI advantage in the low viscosity region of the unconverted fraction from the hydrocracking stage.

In embodiments, the large pore zeolite is a Y zeolite with a BET surface area of from 650 to 825 m²/g, e.g., from 700 to 825 m²/g; a micropore volume of from 0.15 to 0.30 mL/g; a total pore volume of from 0.51 to 0.55 mL/g; and a unit cell size of from 2.415 to 2.445 nm, e.g., from 2.415 to 2.435 nm.

The amount of zeolite in the hydrocracking catalyst is from 1 to 60 wt. % (e.g., from 1.5 to 50 wt. %, or from 2 to 20 wt. %) based on the bulk dry weight of the hydrocracking catalyst.

(B) Amorphous Cracking Component

Due to the extremely low acidity of USY zeolites, the hydrocracking catalyst can benefit from the addition of a secondary amorphous cracking component. An exemplary amorphous cracking component is silica-alumina. However, other materials can be used, such as alumina, silica, magnesia, titania, and zirconia.

In an embodiment, the amorphous cracking component is a highly homogeneous silica-alumina having a surface to bulk (S/B) silica to alumina ratio (Si/A1) of from 0.7 to 1.3 and a crystalline alumina phase present in an amount of not more than 10 wt. %, such as described in U.S. Pat. No. 6,995,112.

In an embodiment, the amorphous silica-alumina material has a mean mesopore diameter of from 7 to 13 nm. In an embodiment, the amorphous silica-alumina material contains SiO₂ in an amount of from 10 to 70 wt. % of the bulk dry weight of the carrier as determined by ICP elemental analysis, a BET surface area of from 450 to 550 m²/g, and a total pore volume of from 0.57 to 1.05 mL/g.

The amount of amorphous cracking component in the catalyst is from 10 to 80 wt. % (e.g., from 30 to 70 wt. %, or from 40 to 60 wt. %) based on the bulk dry weight of the catalyst. The amount of silica in the silica-alumina is from 10 to 70 wt. %, e.g. from 20 to 60 wt. %, or from 25 to 50 wt. %.

(C) Hydrogenation Metal Component

The hydrocracking catalyst disclosed herein further comprises a hydrogenation component which is selected from a Group VIB metal, a Group VIII metal, and combinations thereof. As will be evident to the skilled person, the word “component” in this context denotes the metallic form of the metal, its oxide form, or its sulfide form, or any intermediate, depending on the situation. The hydrogenation metals are selected from Group VIB and Group VIII metals of the Periodic Table. The nature of the hydrogenation metal present in the catalyst is dependent on the catalyst's envisaged application. If, for example, the catalyst is to be used for hydrogenating aromatics in hydrocarbon feeds, the hydrogenation metal used preferably will be one or more noble metals of Group VIII (e.g., platinum, palladium, or combinations thereof). In this case, the Group VIII noble metal is present in an amount of from 0.05 to 5 wt. %, e.g., from 0.1 to 2 wt. %, or from 0.2 to 1 wt. %, calculated as metal, based on the bulk dry weight of the catalyst. If the catalyst is to be used for removing sulfur and/or nitrogen, it will generally contain a Group VIB metal component and/or a non-noble Group VIII metal component. In an embodiment, the hydrogenation metal is molybdenum, tungsten, nickel, cobalt, or a mixture thereof. The Group VIB and/or non-noble Group VIII hydrogenation metal is present in an amount of from 2 to 50 wt. %, e.g., from 5 to 30 wt. %, or from 5 to 25 wt. %, calculated as the metal oxide, based on the bulk dry weight of the catalyst.

Non-noble metal components can be pre-sulfided prior to use by exposure to a sulfur-containing gas (such as H₂S) or liquid (such as a sulfur-containing hydrocarbon stream, e.g., derived from crude oil and/or spiked with an appropriate organic sulfur compound) at an elevated temperature to convert the oxide form to the corresponding sulfide form of the metal.

In an embodiment, the catalyst contains from 1 to 10 wt. % of nickel and from 5 to 40 wt. % of tungsten, based on the bulk dry weight of the catalyst. In another embodiment, the catalyst contains from 2 to 8 wt. % of nickel and from 8 to 30 wt. % of tungsten, based on the bulk dry weight of the catalyst.

Various methods of adding active metals to catalyst compositions are known in the art. Briefly, methods of incorporating active metals include ion exchange, homogeneous deposition precipitation, redox chemistry, chemical vapor deposition, and impregnation. In one embodiment, impregnation is used to incorporate active metals into the catalyst composition. Impregnation involves exposing the catalyst composition to a solution of the metal or metals to be incorporated followed by evaporation of the solvent.

The deposition of at least one of the metals on the catalyst can be achieved in the presence of at least one organic oxygen-containing ligand. The organic oxygen-containing ligand is hypothesized to assist in producing an effective dispersion of metals throughout the catalyst which, in turn, is a factor in the increased selectivity exhibited by the present catalysts.

The organic oxygen-containing ligand can be a mono-dentate, bi-dentate or poly-dentate ligand. Organic ligands can also be a chelating agent. Examples of organic oxygen-containing ligands include carboxylic acids, amino acids, esters, ketones, polyols, amino alcohols, and the like. Examples of suitable carboxylic acids include formic acid, acetic acid, glyoxylic acid, oxalic acid, glycolic acid, lactic acid, malonic acid, succinic acid, malic acid, tartaric acid, citric acid, nitrilotriacetic acid (NTA), ethylenediaminetetraacetic acid (EDTA), ethylene glycol tetraacetic acid (EGTA), and salicylic acid. In an embodiment, nickel citrate solutions are used to impregnate the catalyst composition. Other examples of metal ion-chelate complexes which can be used to impregnate a catalyst or catalyst composition with metals or metal ions include nickel-formate, nickel-acetate, nickel-citrate, nickel-EDTA, nickel-NTA, molybdenum-citrate, and molybdenum-NTA.

Hydrocracking catalysts prepared according the methods disclosed herein maintain high zeolite micropore volume after formation with the metal highly dispersed and of optimum particle size for good catalytic activity. Substantially all of the metal is in the form of reduced crystallites of metal located outside the zeolite channels with little or none of the metal located within the zeolite channels. No appreciable ion exchange of the metal with zeolite acid sites therefore occurs within the zeolite channels. As a result, the percentage of residual zeolite micropore volume is at least 50%, e.g., at least 80%, at least 90%, at least 95%, or even about 100%. As defined herein, “percentage of residual zeolite micropore volume” refers to the percentage of zeolite micropore volume of the integral catalyst as measured by the t-plot method relative to the micropore volume of the zeolite component alone. In other words, the zeolite micropore volume of the integral catalyst as measured by the t-plot method is at least 50%, e.g., at least 80%, at least 90%, at least 95%, or even about 100% of the zeolite component alone. The high percentage of residual zeolite micropore volume allows for maximum utilization of metal for catalytic activity.

(D) Other Components

The catalyst can also contain one or more binders. The binder(s) present in the catalyst compositions suitably comprise inorganic oxides. Both amorphous and crystalline binders can be applied. Examples of suitable binders include silica, alumina, clays, and zirconia. An exemplary binder is alumina. The amount of binder in the catalyst composition is from 0 to 35 wt. % (e.g., from 0.1 to 25 wt. %, from 10 to 30 wt. %, or from 15 to 25 wt. %) based on the bulk dry weight of the catalyst.

The catalyst can contain one or more promoters selected from the group consisting of boron, fluoride, aluminum, silicon, phosphorus, manganese, zinc, and mixtures thereof. Promoters are typically added to a catalyst to improve selected properties of the catalyst or to modify the catalyst activity and/or selectivity. The amount of promoter in the catalyst is from 0 to 10 wt. % (e.g., from 0.1 to 5 wt. %) based on the bulk dry weight of the catalyst.

Preparation of the Hydrocracking Catalyst

The zeolite with or without a binder can be formed into various shapes such as pills, pellets, extrudates, spheres, etc. In certain embodiments, the hydrocracking catalyst according to the present disclosure is in the form of an extrudate. Extrudates are prepared by conventional means which involves mixing of the composition, either before or after adding metallic components, with the binder and a suitable peptizing agent to form a homogeneous dough or thick paste having the correct moisture content to allow for the formation of extrudates with acceptable integrity to withstand direct calcination. The dough then is extruded through a die to give the shaped extrudate. A multitude of different extrudate shapes are possible, including cylinders, cloverleaf, dumbbell and symmetrical and asymmetrical polylobates.

In one embodiment, a shaped hydrocracking catalyst is prepared by: (a) forming an extrudable mass containing at least an amorphous inorganic oxide; (b) extruding then calcining the mass to form a calcined extrudate; (c) exposing the calcined extrudate to an impregnation solution containing at least one metal and an organic oxygen-containing ligand to form an impregnated extrudate; and (d) drying the impregnated extrudate, at a temperature below the decomposition temperature of the organic oxygen-containing ligand and sufficient to remove the impregnation solution solvent, to form a dried impregnated extrudate.

Hydroprocessing

For the purposes of this discussion, the term hydroprocessing is intended to refer to either hydrotreating or hydrocracking. Hydroisomerization and hydrofinishing, while also a type of hydroprocessing, will be treated separately because of their different functions in the process scheme.

The term “hydrotreating” refers to a process that converts sulfur- and/or nitrogen-containing hydrocarbon feeds into hydrocarbon products with reduced sulfur and/or nitrogen content, typically in conjunction with a hydrocracking function, and which generates hydrogen sulfide and/or ammonia (respectively) as by-products. Generally, in hydrotreating operations cracking of the hydrocarbon molecules (i.e., breaking the larger hydrocarbon molecules into smaller hydrocarbon molecules) is minimized. For the purpose of this discussion the term hydrotreating refers to a hydroprocessing operation in which the conversion is 20% or less, where the extent of “conversion” relates to the percentage of the feed boiling above a reference temperature (e.g., 700° F.) which is converted to products boiling below the reference temperature. The conversion can be measured by any appropriate means.

“Hydrocracking” refers to a catalytic process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins. In contrast to hydrotreating, the conversion rate for hydrocracking, for the purpose of this disclosure, is defined as more than 20%.

By varying the conversion rate of the hydroprocessing operation, the amount of diesel or of lubricating base oil can be maximized. For example, by operating at a higher conversion, typically greater than about 20% conversion, the amount of diesel produced by the process can be increased, since a portion of the C₂₀₊ molecules present in the feed will be cracked into products within the boiling range of transportation fuels. Similarly, by minimizing the amount of conversion in this step, generally less than 20% conversion and preferably 5% conversion or less, the amount of base oil produced can be maximized due to the very low cracking rate.

The hydrocracking reaction zone is maintained at conditions sufficient to effect a boiling range conversion of the hydrocarbon feed to the hydrocracking reaction zone, so that the liquid hydrocrackate recovered from the hydrocracking reaction zone has a normal boiling point range below the boiling point range of the feed. The hydrocracking step reduces the size of the hydrocarbon molecules, hydrogenates olefin bonds, hydrogenates aromatics, and removes traces of heteroatoms resulting in an improvement in fuel and/or base oil product quality.

The process disclosed herein can employ a wide variety of hydrocarbon feedstocks from many different sources, such as crude oil, virgin petroleum fractions, recycle petroleum fractions, shale oil, liquefied coal, tar sand oil, synthetic paraffins from normal alpha-olefins, recycled plastic feedstocks, petroleum distillates, solvent-deasphalted petroleum residua, shale oils, coal tar distillates, hydrocarbon feedstocks derived from plant, animal, and/or algal sources, and combinations thereof. Other feedstocks that can be used include synthetic feeds, such as those derived from Fischer-Tropsch processes. Other suitable feedstocks include those heavy distillates normally defined as heavy straight-run gas oils and heavy cracked cycle oils, as well as conventional fluid catalytic cracking feed and portions thereof. In general, the feed can be any hydrocarbon-containing feedstock susceptible to hydroprocessing catalytic reactions, particularly hydrocracking reactions.

Typical hydrocarbon feedstocks include feeds with an initial boiling point of at least 650° F. (343° C.), e.g., at least 700° F. (371° C.), or at least 750° F. (399° C.). Alternatively, a feed can be characterized using a T5 boiling point, such as a feed with a T5 boiling point of at least 650° F. (343° C.), e.g., at least 700° F. (371° C.), or at least 750° F. (399° C.). A “T5” boiling point for a feed is defined as the temperature at which 5 wt. % of the feed will boil off. Typical feeds include feeds with a final boiling point of 1150° F. (621° C.), e.g., 1100° F. (593° C.) or less, or 1050° F. (566° C.) or less. Alternatively, a feed can be characterized using a T95 boiling point, such as a feed with a T95 boiling point of 1150° F. (621° C.), e.g., 1100° F. (593° C.) or less, or 1050° F. (566° C.) or less. A″T95″ boiling point is a temperature at which 95 wt. % of the feed will boil.

The hydrocarbon feedstock can contain organic sulfur compounds and organic nitrogen compounds. The total sulfur content can range from 0.1 to 7% by weight of total sulfur (e.g., from 0.2 to 5% by weight of total sulfur, or from 0.5 to 4% by weight of total sulfur). The can contain from 100 to 5000 ppm to by weight of total nitrogen (e.g., from 500 to 5000 ppm of total nitrogen). A representative hydrocarbon feedstock such as VGO can contain at least 1% by weight of sulfur and at least 500 ppm by weight of total nitrogen.

The hydrocarbon feedstock can have a high polycyclic aromatics content. In embodiments, the polycyclic aromatic index (PCI) can be at least 1000, e.g., at least 2000, at least 2500, at least 3000, from 1000 to 5000, from 2000 to 5000, or from 3000 to 5000.

The hydrocarbon feedstock may have been processed (e.g., by hydrotreating) prior to the present process to reduce or substantially eliminate its heteroatom, metal or aromatic content. The hydrocarbon feedstock can also comprise recycle components.

Representative hydrocracking conditions include a temperature of from 450° F. to 900° F. (232° C. to 482° C.), e.g., from 650° F. to 850° F. (343° C. to 454° C.); a pressure of from 500 to 5000 psig (3.5 to 34.5 MPa), e.g., from 1500 to 3500 psig (10.4 to 24.2 MPa); a liquid hourly space velocity (LHSV) of from 0.1 to 15 h⁻¹, e.g., from 0.25 to 2.5 h⁻¹; and a total hydrogen treat gas rate of from 500 to 10000 SCF/B (89.1 to 1780 m³ H₂/m³ feed).

In embodiments, the hydrocracking conditions employed are sufficient to attain a relatively low conversion level, e.g., not more than 30%, not more than 25%, greater than 20% to not more than 30%, or greater than 20% to not more than 25%.

Hydrocracking can advantageously be carried out in just one or several fixed bed catalytic beds, in one or more reactors, in a “single-stage” hydrocracking scheme, with or without intermediate separation, or in a “two-stage” hydrocracking scheme, the “single-stage” or “two-stage” schemes being operated with or without liquid recycling of the unconverted fraction, optionally in combination with a conventional hydrotreating catalyst located upstream of the hydrocracking catalyst. Such processes are widely known in the prior art. In performing the hydrocracking and/or hydrotreating operation, more than one catalyst type can be used in the reactor(s). The different catalyst types can be separated into layers or mixed.

Typical hydrotreating reaction conditions can vary over a wide range. Representative hydrotreating conditions include a reaction temperature from 550° F. to 800° F. (288° C. to 427° C.); a total pressure of from 300 to 3000 psig (2.1 to 20.7 MPa), e.g., from 700 to 2500 psig (4.8 to 17.2 MPa); a LHSV of from 0.1 h⁻¹ to 20 h⁻¹, e.g., from 0.2 h⁻¹ to 10 h⁻¹; and a hydrogen treat gas rate of from 1200 to 6000 SCF/B (213 to 1068 m³ H₂/m³ feed).

Hydrocracking the hydrocarbon feedstock produces a converted fraction and an unconverted fraction boiling above 700° F. (371° C.). The unconverted fraction or unconverted oil (UCO) is recovered by distillation and typically has a distillation end point temperature of at most about 1100° F. (593° C.).

The converted products from the hydrocracking zone are described as having a boiling range maximum of 700° F. (371° C.) and thus contain middle distillate portions having a boiling range of from to 250° F. (121° C.) to 700° F. (371° C.). The middle distillate portions of the converted products can be used as one or more transportation fuel compositions and/or can be sent one or more existing fuel pools. Examples of such fuel compositions/pools include diesel, kerosene and/or jet fuels. Middle distillate portions of the converted products can be split (e.g., by fractionation or the like) into a kerosene or jet fuel cut having boiling point range of from 280° F. to 525° F. (138° C. to 274° C.) and a diesel cut having a boiling range of from 550° F. to 700° F. (288° C. to 371° C.).

The unconverted fraction, due to its improved properties (e.g., higher saturates content, higher VI, lower nitrogen- and/or S-containing contaminants content), can be further processed for use as a lube base stock.

In embodiments, the unconverted fraction has a viscosity index of at least 80, e.g., at least 90, at least 95, at least 100, at least 105, at least 110, at least 115, at least 120, at least 125, at least 130, at least 135, or at least 140. The unconverted fraction generally has a viscosity index of not greater than 160, e.g., not greater than 150. Alternatively, the unconverted fraction can have a viscosity index of from 80 to 140, e.g., from 90 to 140, from 95 to 140, from 100 to 140, from 105 to 140, from 110 to 140, or from 95 to 120.

In embodiments, the unconverted fraction has a kinematic viscosity at 100° C. of at least 1 mm²/s, e.g., at least 2 mm²/s, at least 3 mm²/s, at least 4 mm²/s, at least 5 mm²/s. Generally, the unconverted fraction has a kinematic viscosity at 100° C. of not more than 15 mm²/s, e.g., not more than 12 mm²/s, not more than 10 mm²/s, or not more than 8 mm²/s. Alternatively, the unconverted fraction can have a kinematic viscosity at 100° C. of from 2 to 10 mm²/s, e.g., from 2 to 8 mm²/s, from 4 to 10 mm²/s, or from 4 to 8 mm²/s.

Since the hydrocracking catalyst employed in the process disclosed herein removes a substantial portion of the organic nitrogen-containing and organic sulfur-containing compounds from the hydrocarbon feedstock, the nitrogen and sulfur contents of the unconverted fraction are typically less than 25 ppm, e.g., less than 10 ppm, or even less than 1 ppm.

The unconverted fraction produced by the hydrocracking step can be dewaxed following hydrocracking to reduce pour point. The dewaxing can be done by a number of different processes, including hydroisomerization dewaxing, solvent dewaxing, or a combination thereof.

Hydroisomerization dewaxing is achieved by contacting a waxy feed with a hydroisomerization catalyst in an isomerization zone under hydroisomerizing conditions. The hydroisomerization catalyst comprises a shape selective intermediate pore size molecular sieve, a noble metal hydrogenation component, and a refractory oxide support. The shape selective intermediate pore size molecular sieve can be selected from the group consisting of SAPO-11, SAPO-31, SAPO-41, SM-3, ZSM-22, ZSM-23, ZSM-35, ZSM-48, ZSM-57, SSZ-32, ferrierite, and combinations thereof. SAPO-11, SM-3, SSZ-32, ZSM-23, and combinations thereof are more preferred. Preferably the noble metal hydrogenation component is platinum, palladium, or combinations thereof.

The hydroisomerization dewaxing conditions employed depend on the feed used, the hydroisomerization catalyst used, whether or not the catalyst is sulfided, and the desired pour point of the product. Representative hydoisomerization dewaxing operating conditions include a temperature of from 550° F. to 700° F. (288° C. to 371° C.), e.g., from 590° F. to 675° F. (310° C. to 357° C.); a total pressure of from 15 to 3000 psig (0.10 to 20.68 MPa), e.g., from 100 to 2500 psig (0.69 to 17.24 MPa); a LHSV of from 0.1 to 20 h⁻¹, e.g., from 0.1 to 5 h⁻¹; and a hydrogen treat gas rate of from 300 to 10000 SCF/B (53 to 1781 m³ H₂/m³ feed), e.g., from 500 to 10000 SCF/B (89 to 1780 m³ H₂/m³ feed).

Suitable solvent dewaxing processes are described in “Lubricant Base Oil and Wax Processing,” Marcel Dekker, 81-118 (1994).

Optionally, the base oil produced by dewaxing can be hydrofinished. Hydrofinishing is intended to improve the oxidation stability, UV stability, and appearance of lubricating base oil products by removing aromatics, olefins, color bodies, and solvents. A general description of hydrofinishing can be found in U.S. Pat. Nos. 3,852,207 and 4,673,487.

Products

The lube base stocks prepared according to the methods described herein can meet the standards designated by the American Petroleum Institute (API) for Group II or Group III lubricant base oils (API Publication 1509).

In embodiments, the lube base stock has a VI of from 80 to 140, e.g., from 80 to 135, from 80 to 130, from 80 to 125, from 80 to 120, from 90 to 140, from 90 to 135, from 90 to 130, from 90 to 125, from 90 to 125, from 90 to 120, from 95 to 140, from 95 to 135, from 95 to 130, from 95 to 125, or from 95 to 120.

In embodiments, the lube base stock has a kinematic viscosity at 100° C. of at least 1 mm²/s, e.g., at least 2 mm²/s, at least 3 mm²/s, at least 4 mm²/s, at least 5 mm²/s. Generally, the lube base stock has a kinematic viscosity at 100° C. of not more than 15 mm²/s, e.g., not more than 12 mm²/s, not more than 10 mm²/s, or not more than 8 mm²/s. Alternatively, the lube base stock can have a kinematic viscosity at 100° C. of from 2 to 10 mm²/s, e.g., from 3 to 8 mm²/s, from 3 to 10 mm²/s, from 4 to 10 mm²/s, or from 4 to 8 mm²/s.

In embodiments, the lube base stock has a pour point of less than 0° C., e.g., less than −5° C., less than −10° C., or less than −15° C.

### EXAMPLES

The following illustrative examples are intended to be non-limiting.

### Example 1

### Catalyst A—Comparative Hydrocracking Catalyst

A comparative hydrocracking catalyst was prepared per the following procedure: 67 parts by weight silica-alumina powder (obtained from Sasol), 25 parts by weight pseudo boehmite alumina powder (obtained from Sasol), and 8 parts by weight of USY zeolite were mixed well.

The USY zeolite employed had the following properties: a SiO₂/Al₂O₃ mole ratio of about 60, an Alpha value of about 25, and a zeolite acid site density in the range of from 100 to 300 micromole/g.

A diluted HNO₃ acid aqueous solution (1 wt. %) was added to the mix powder to form an extrudable paste. The paste was extruded in 1/16 inch asymmetric quadrilobe shape, and dried at 250° F. (121° C.) overnight. The dried extrudates were calcined at 1100° F. (593° C.) for 1 hour with purging excess dry air and cooled down to room temperature.

Impregnation of Ni and W was done using a solution containing ammonium metatungstate and nickel nitrate in concentrations equal to the target metal loadings of 4 wt. % NiO and 28 wt. % WO₃ based on the bulk dry weight of the finished catalyst. The total volume of the solution matched the 103% water pore volume of the base extrudate sample (incipient wetness method). The metal solution was added to the base extrudates gradually while tumbling the extrudates. When the solution addition was completed, the soaked extrudates were aged for 2 hours. Then the extrudates were dried at 250° F. (121° C.) overnight. The dried extrudates were calcined at 842° F. (450° C.) for 1 hour with purging excess dry air, and cooled down to room temperature.

### Example 2

### Catalyst B—Modified Hydrocracking Catalyst

A modified Ni/W hydrocracking catalyst was prepared using extrudates prepared with the same formulation as that for Catalyst A with the exception that the USY zeolite employed had the following properties: a SiO₂/Al₂O₃ mole ratio of about 100, an Alpha value of about 2, and a zeolite acid site density in the range of from 1 to 50 micromole/g.

Impregnation of Ni and W was done using a solution containing ammonium metatungstate and nickel nitrate in concentrations equal to the target metal loadings of 4 wt. % NiO and 28 wt. % WO₃ based on the bulk dry weight of the finished catalyst. Citric acid (used as a ligand), in an amount equal to 10 wt. % of the bulk dry weight of the finished catalyst, was added to the Ni/W solution. The solution was heated to above 120° F. (49° C.) to ensure a completed dissolved (clear) solution. The total volume of the metal solution matched the 103% water pore volume of the base extrudates (incipient wetness method). The metal solution was added to the base extrudates gradually while tumbling the extrudates. When the solution addition was completed, the soaked extrudates were aged for 2 hours. Then the extrudates were dried at 400° F. (205° C.) for 2 hours with purging excess dry air, and cooled down to room temperature.

### Example 3

### Hydrocracking Performance

A vacuum gas oil feedstock having the properties in Table 1 was hydroprocessed in a once-through, down-flow microunit equipped with two reactors and one stripper. A total volume of 11 mL of catalyst was loaded in the two reactors with 4.2 mL of Catalyst C (a commercial NiMo hydrotreating catalyst) disposed in reactor 1 and a layered catalyst system of 2.3/0.6/1.5/2.4 mL of Catalysts A/C/A/C or a layered catalyst system of 2.3/0.6/1. 5/2.4 mL of Catalysts B/C/B/C disposed in reactor 2. All catalysts were shortened to an L/D of 1 to 2. The void spaces among catalyst extrudates were filled with 100 mesh alundum as interstitial to improve contacting and to prevent channeling. The catalyst was sulfided before the hydrocarbon feedstock was fed for the reaction.

TABLE 1
Properties of VGO Feed

| | Feedstock |
|---|---|
| API Gravity | 21.4 |
| Sulfur (wt. %) | 2.05 |
| Nitrogen (ppm) | 987 |
| H by NMR (wt. %) | 12.41 |
| Polycyclic Aromatics Index (PCI) | 1448 |
| VI | 76 |
| Vis @ 100° C. (mm²/s) | 7.39 |
| Vis @ 40° C. (mm²/s) | 17.33 |
| UV Survey | |
| 226 nm | 26.626 |
| 305 nm | 5.624 |
| 340 nm | 1.579 |
| 385 nm | 0.168 |
| 435 nm | 0.012 |
| ASTM D2887 SimDis (wt. %, -° F.) | |
| IBP/5 | 651/717 |
| 10/30 | 740/789 |
| 50/ | 825/ |
| 70/90 | 863/924 |
| 95/EP | 957/1027 |

Hydroprocessing conditions included a unit pressure of 2250 psig (2100 psia once-through H₂), a hydrogen rate of 5000 SCF/B, and a LHSV of 1.0 h⁻¹. Stripper bottom (STB, 670° F.+) was submitted for hydrocarbon composition study and for VI inspection at hydrocracking conversions (<700° F.) from 20% to 60%. The stripper bottom was solvent dewaxed at −15° C. to provide lube base stock products. The results are summarized in Table 2.

TABLE 2
Catalyst Performance

| | Catalyst | Catalyst | Catalyst | Catalyst |
|---|---|---|---|---|
| | A | B | A | B |
| C.A.T. (° F.) | 720 | 700 | 736 | 710 |
| Conversion <700° F. (wt. %) | 30.10 | 18.20 | 40.30 | 22.54 |
| Non-Loss Yield (wt. %) | | | | |
| C₄— | 0.94 | 0.35 | 1.41 | 0.51 |
| C₅ to 180° F. | 1.06 | 0.56 | 1.93 | 0.92 |
| 180° F. to 250° F. | 2.08 | 0.95 | 3.01 | 1.73 |
| 250° F. to 500° F. | 12.69 | 7.15 | 19.32 | 9.85 |
| 550° F. to 670° F. | 10.33 | 6.71 | 11.78 | 7.37 |
| 670° F.+ | 71.93 | 83.81 | 61.87 | 79.69 |
| Stripper Bottoms | | | | |
| Sulfur (ppm) | <5 | 18.33 | <5 | <5 |
| Nitrogen (ppm) | <0.3 | 0.31 | <0.3 | <0.3 |
| Lube Yield (STB/Feed) | 70.7 | 81.8 | 61.5 | 78.0 |
| (wt. %) | | | | |
| Aromatics by HPLC (wt. %) | 8.2 | 10.2 | 5.2 | 1.2 |
| Hydrocarbon Type (LV %) | <5 | 18.33 | <5 | <5 |
| Paraffinic | 20.6 | 22.4 | 25.4 | 31.3 |
| Naphthenic | 70.1 | 66.9 | 69.7 | 66.3 |
| Aromatic | 9.3 | 10.7 | 4.9 | 2.4 |
| 1-Ring Naphthenic | 26.2 | 28.3 | 33.1 | 39.5 |
| 2-Ring Naphthenic | 18.1 | 16.7 | 19.1 | 17.3 |
| 3-Ring Naphthenic | 13.4 | 11.2 | 12.1 | 9.6 |
| PCI | 83 | 62 | 84 | 33 |
| Waxy VI | 116 | 114 | 125 | 132 |
| Vis @ 100° C. (mm²/s) | 5.366 | 6.009 | 4.956 | 5.14 |
| Vis @ 70° C. (mm²/s) | 10.83 | 38.98 | 9.674 | 10.01 |
| Cloud Point (° C.) | 43 | 43 | 43 | 42 |
| Pour Point (° C.) | 34 | 36 | 36 | 35 |
| Lube Yield (STB/Feed) | 70.7 | 81.8 | 61.5 | 78.0 |
| (wt. %) | | | | |
| Solvent Dewaxed | | | | |
| Oil at −15° C. | | | | |
| Wax Content (wt. %) | 15.9 | 15.7 | 21.6 | 21.8 |
| VI | 99 | 97 | 109 | 117 |
| Vis @ 100° C. (mm²/s) | 5.718 | 6.009 | 5.222 | 5.283 |
| Vis @ 70° C. (mm²/s) | 35.68 | 38.98 | 29.34 | 28.78 |

The results in Table 2 show that the catalyst B system can match a comparable VI to the catalyst A system but at much lower hydrocracking conversion thereby providing improved STB (e.g., base oil feedstock) quality and in higher yield.

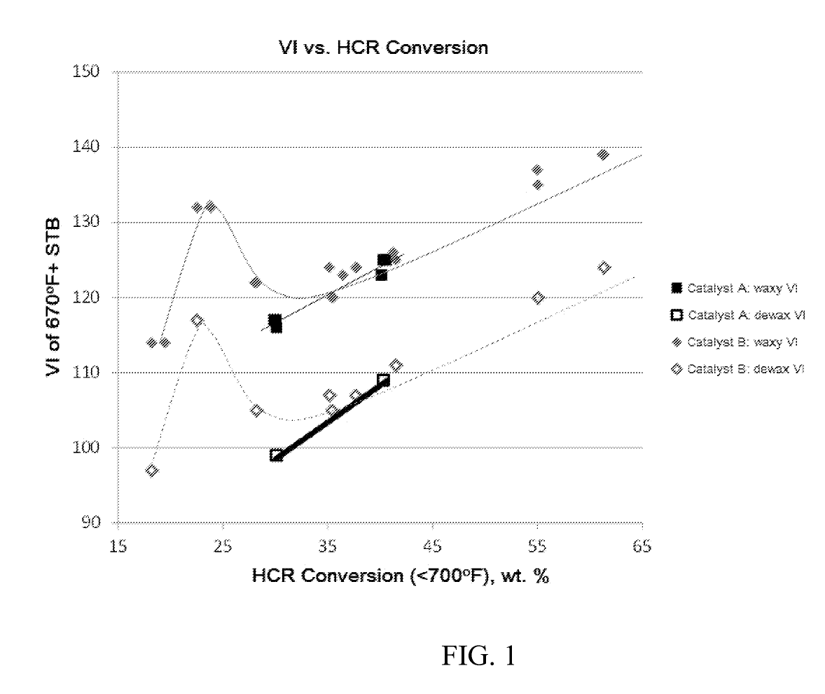

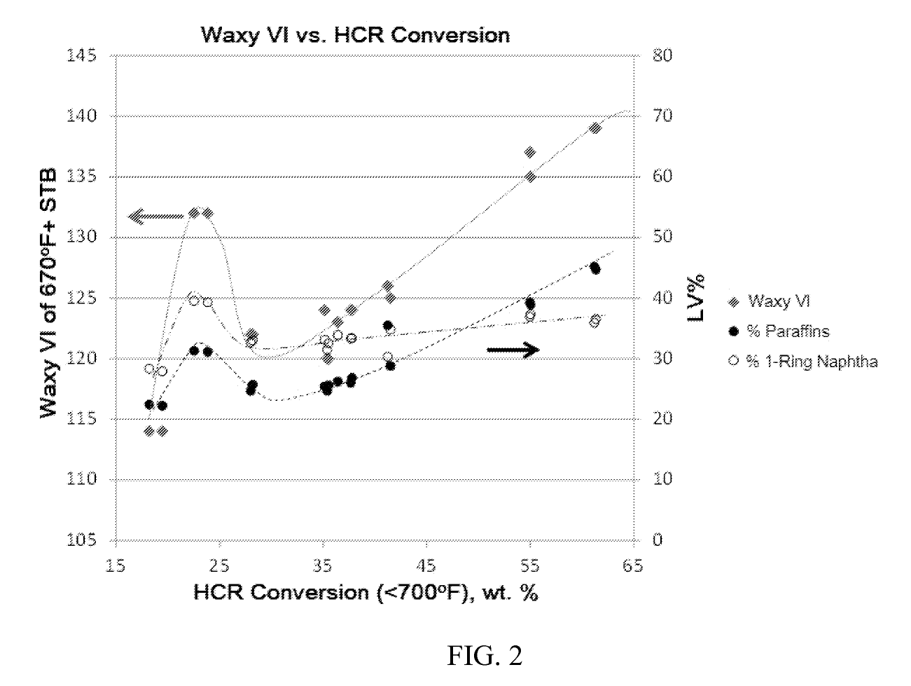

FIG. 1 indicates that a high waxy VI of 132 was produced at conversion levels of less than 25%. In FIG. 2, compositional analysis on the STB shows that the high VI at low conversion can be attributed to the high paraffinic and low aromatic hydrocarbon in the STB due to the mild cracking and high aromatics saturation capability associated with Catalyst B.

### Example 4

A mildly hydroprocessed unconverted oil (UCO) feed having the properties in Table 3 was hydrocracked in a microunit using 6 mL of Catalyst B extrudates shortened to an L/D of 1 to 2. The void spaces among catalyst extrudates were filled with 100 mesh alundum as interstitial to improve contacting and to prevent channeling. The catalyst was sulfided before the UCO was fed for the reaction.

TABLE 3
Properties of UCO Feed

| | Feedstock |
|---|---|
| API Gravity | 29.0 |
| Sulfur (ppm) | 1053 |
| Nitrogen (ppm) | 103 |
| Hot Heptane Asphaltenes (ppm) | 64 |
| VI | 120 |
| Vis @ 100° C. (mm²/s) | 4.45 |
| Vis @ 70° C. (mm²/s) | 8.52 |
| H by NMR (wt. %) | 12.75 |
| PCI | 1851 |
| Hydrocarbon Type (LV %) | |
| Paraffinic | 30.1 |
| Naphthenic | 33.1 |
| Aromatic | 35.5 |
| ASTM D2887 SimDis (wt. %, -° F.) | |
| IBP/5 | 455/597 |
| 10/30 | 645/733 |
| 50/ | 787/ |
| 70/90 | 846/943 |
| 95/EP | 990/1096 |
| Wt. % <707° F. | 22.5 |
| Solvent Dewaxed Oil at −15° C. | |
| Wax Content (wt. %) | 24.1 |
| Oil in Wax (wt. %) | 9.7 |
| VI | 97 |
| Vis @ 100° C. (mm²/s) | 4.61 |
| Vis @ 40° C. (mm²/s) | 25.07 |

Hydroprocessing conditions included a hydrogen partial pressure of 1900 psia, a hydrogen rate of 3500 SCF/B, and a LHSV of 1.87 h⁻¹. Hydrocracked STB product (707° F.+) was submitted for hydrocarbon composition analysis and was solvent dewaxed at −15° C. to provide lube base stock products. The properties of the produced lube base stocks are summarized in Table 4.

TABLE 4
Catalyst Performance

| | | |
|---|---|---|
| Run Hours | 476 | 668 |
| C.A.T. (° F.) | 725 | 735 |
| Conversion <707° F. (wt. %) | 12.23 | 14.70 |
| Non-Loss Yield (wt. %) | | |
| C₄— | 0.51 | 0.57 |
| C₅ to 180° F. | 0.72 | 0.90 |
| 180° F. to 270° F. | 1.15 | 1.72 |
| 270° F. to 554° F. | 8.33 | 10.12 |
| 554° F. to 707° F. | 21.37 | 21.19 |
| 707° F. to 800° F. | 29.52 | 27.93 |
| 800° F. to 900° F. | 24.46 | 23.46 |
| 900° F.+ | 14.82 | 15.37 |
| Stripper Bottoms | | |
| Stripper ASL Cut Point (° F.) | 709 | 712 |
| STB TPG | | |
| IBP/5 | 655/712 | 652/715 |
| 50/ | 816/ | 811/ |
| 95/EP | 997/1090 | 996/1090 |
| Sulfur (ppm) | 19.4 | 15.8 |
| Nitrogen (ppm) | 0.96 | 0.74 |
| Hydrocarbon Type (LV %) | | |
| Paraffinic | 38.2 | 40.4 |
| Naphthenic | 52.1 | 51.1 |
| Aromatic | 9.7 | 8.5 |
| Solvent Dewax | | |
| (−15° C. Pour Point) | | |
| Wax Content (wt. %) | 32.7 | 32.3 |
| Oil in Wax (wt. %) | 12.65 | 13.14 |
| VI | 117 | 121 |
| Vis @ 100° C. (mm²/s) | 5.51 | 5.48 |
| Vis @ 70° C. (mm²/s) | 30.74 | 29.94 |

The results that the catalyst effectively reduced the sulfur and nitrogen content in the hydrocracked STB product (707° F.+). Moreover, the hydrocracked STB product gave a waxy VI of 140 at 725° F. CAT, 20 numbers higher than the VI of the feed. Proportionally, the dewaxed oil (by solvent dewaxing at −15° C. pour point) gave a VI of 117. The hydrocracked STB product also contained 32 wt. % of wax, higher than wax content (24 wt. %) of the feed which suggests that the catalyst preserves the paraffinic components in the hydrocracked product, in favor of a VI improvement.

The waxy VI of the hydrocracked STB product increased from 139 to 142 when the CAT was raised to from 725° F. to 735° F. Correspondingly, the synthetic conversion was increased from 12 wt. % to 15 wt. %. Solvent dewaxing at −15° C. pour point indicated that the base oil feedstock contained about 32 wt. % wax at 735° F. CAT, the same as that at 725° F. CAT. The dewaxed oil gave a VI of 121, in the range of a Group III oil.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

Unless otherwise specified, the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A hydrocracking catalyst, comprising: (a) a USY zeolite component having a SiO₂/Al₂O₃ mole ratio of at least 50, an alpha value of not more than 5, and a zeolite acid site density of from 1 to 100 micromole/g; (b) an amorphous cracking component; and (c) at least one hydrogenation metal component selected from the group consisting of a Group VIB metal, a Group VIII metal, and mixtures thereof.

2. The catalyst of claim 1, wherein the zeolite component has a SiO₂/Al₂O₃ mole ratio of from 80 to 150.

3. The catalyst of claim 1, wherein the zeolite component has an alpha value of from 0.01 to 3.

4. The catalyst of claim 1, wherein the zeolite component has a zeolite acid site density of from 1 to 50 micromole/g.

5. The catalyst of claim 1, wherein the hydrocracking catalyst has a residual zeolite micropore volume of at least 50%.

6. The catalyst of claim 1, wherein the hydrocracking catalyst has a residual zeolite micropore volume of at least 80%.

7. The catalyst of claim 1, wherein the amorphous cracking component is a silica-alumina containing SiO₂ in an amount of from 10 to 70 wt. % of the bulk dry weight of the carrier as determined by ICP elemental analysis and having a mean mesopore diameter of from 7 to 13 nm, a BET surface area of from 450 to 550 m²/g, and a total pore volume of from 0.57 to 1.05 mL/g.

8. The catalyst of claim 1, wherein the hydrogenation metal component is selected from the group consisting of molybdenum, tungsten, nickel, cobalt, and mixtures thereof.

9. The catalyst of claim 1, wherein deposition of the hydrogenation metal on the catalyst is achieved in the presence of at least one organic oxygen-containing ligand.

10. The catalyst of claim 9, wherein the at least one organic oxygen-containing ligand is selected from the group consisting of carboxylic acids, amino acids, esters, ketones, polyols, amino alcohols, and mixtures thereof.

11. The catalyst of claim 10, wherein the at least organic oxygen-containing ligand is a carboxylic acid is selected from the group consisting of formic acid, acetic acid, glyoxylic acid, oxalic acid, glycolic acid, lactic acid, malonic acid, succinic acid, malic acid, tartaric acid, citric acid, nitrilotriacetic acid (NTA), ethylenediaminetetraacetic acid (EDTA), ethylene glycol tetraacetic acid (EGTA), salicylic acid, and mixtures thereof.

12. A method for preparing a lube base stock having a viscosity index of from 80 to 140, comprising
(a) contacting a hydrocarbon feedstock with the hydrocracking catalyst of claim 1 under hydrocracking conditions sufficient to attain a conversion level of not more than 30% below 700° F. (371° C.), so as to form a hydrocracked product;
(b) separating the hydrocracked product into a converted product having a boiling range maximum of 700° F. (371° C.) and an unconverted product having a boiling range minimum of 700° F. (371° C.); and
(c) dewaxing at least a portion of the unconverted product to obtain a lube base stock.

13. The method of claim 12, wherein the conversion level is from greater than 20% to not more than 25%.

14. The method of claim 12, wherein the lube base stock has a kinematic viscosity at 100° C. of from 2 to 10 mm²/s.

15. The method of claim 12, wherein the lube base stock is a Group II base oil or a Group III base oil.

16. The method of claim 12, wherein the dewaxing is performed by solvent dewaxing or hydroisomerization dewaxing.
